(19) United States
(12) Patent Application Publication
(10) Pub. No.: US 2026/0216753 A1
(43) Pub. Date: Jul. 30, 2026

(54) SYSTEM AND METHOD FOR REJECTING WALL BOARDS

(71) Applicant: Georgia-Pacific Gypsum LLC, Atlanta, GA (US)

(72) Inventor: Matthew E. Arinez, Kennesaw, GA (US)

(21) Appl. No.: 19/146,234

(22) PCT Filed: Feb. 1, 2024
(86) PCT No.: PCT/IB2024/050911

§ 371 Date: Jul. 8, 2025

Related U.S. Application Data
(60) Provisional application No. 63/447,645, filed on Feb. 23, 2023.

(51) Int. Cl. B07C 5/14; B07C 5/36

(52) U.S. Cl. CPC B07C 5/14; B07C 5/362

(57) ABSTRACT

Systems, apparatuses, methods, computing devices, and/or the like are provided. A system for system for rejecting one or more wall boards may include a frame; a lower roller configured to operably engage the one or more wall boards; a plurality of pivot roller assemblies configured to apply one or more forces to the lower roller, wherein the lower roller is configured to apply the one or more forces to the one or more wall boards to which the lower roller is operably engaged; at least one idler roller, wherein the at least one idler roller is aligned with the lower roller; a controller configured to send one or more signals to the plurality of pivot roller assemblies, wherein the one or more signals are configured to adjust the one or more forces applied to the lower roller based on one or more thresholds.

### CROSS REFERENCE TO RELATED APPLICATION

This application claims the benefit of U.S. Provisional Application No. 63/447,645, filed Feb. 23, 2023, which is hereby incorporated by reference in its entirety.

### TECHNICAL FIELD

The present disclosure relates generally to materials manufacturing, and more particularly to ensuring reliable rejection of defective, non-conforming wall board during the manufacturing process.

### BACKGROUND

During wall board production, undesirable wall boards (e.g., oversized wall boards) may be inadvertently introduced into the manufacturing process and potentially cause delays in the manufacturing process (e.g., by causing jams that may lead to a pile-up of wall boards). Wall board rejection may also be required if equipment downstream in the production process is inoperable and new boards cannot be introduced.

To prevent undesirable wall boards from entering the production process, passive (e.g., non-driven) pressure rollers may be positioned on a production line and engage the undesirable wall boards during the manufacturing process. These pressure rollers may eject the undesirable wall boards (e.g., oversized wall boards) by applying an ejection force to the undesirable wall boards. However, in certain instances, the wall boards may overcome the ejection force. For example, sufficiently long, heavy, and/or textured boards may overcome the ejection force, remain on the production line, and interfere with the manufacturing process. Undesirable wall boards that are not ejected from the manufacturing process may then need to be removed by technicians, causing further delays in production.

Through applied effort, ingenuity, and innovation, Applicant has solved problems relating to failure to reject undesirable wallboard by developing solutions embodied in the present disclosure, which are described in detail below.

### BRIEF SUMMARY

In general, various embodiments of the present disclosure provide methods, apparatuses, systems, computing devices, computing entities, and/or the like.

According to various embodiments, there is provided a system for rejecting one or more wall boards, the system including a frame; a lower roller configured to operably engage the one or more wall boards; a plurality of pivot roller assemblies configured to apply one or more forces to the lower roller, wherein the lower roller is configured to apply the one or more forces to the one or more wall boards to which the lower roller is operably engaged; at least one idler roller, wherein the at least one idler roller is aligned with the lower roller; a controller configured to send one or more signals to the plurality of pivot roller assemblies, wherein the one or more signals are configured to adjust the one or more forces applied to the lower roller based on one or more thresholds, wherein the one or more forces are configured to reject the one or more wall boards if the one or more wall boards exceeds the one or more thresholds.

In some embodiments, the one or more thresholds include a length of the one or more wall boards.

In some embodiments, the one or more wall boards include a material selected from a group consisting of: gypsum and fiberglass.

In some embodiments, the plurality of pivot roller assemblies includes a first pivot roller assembly, a second pivot roller assembly, and a third pivot roller assembly, wherein the first pivot roller assembly is configured to apply a first force to the lower roller, the second pivot roller assembly is configured to apply a second force to the lower roller, and the third pivot roller assembly is configured to apply a third force to the lower roller.

In some embodiments, each pivot roller assembly of the plurality of pivot roller assemblies includes a pneumatic cylinder, a roller shaft operably connected to the pneumatic cylinder, and one or more wheels operably connected to the roller shaft, and wherein the pneumatic cylinder is configured to tilt the roller shaft horizontally or vertically with respect to the frame.

In some embodiments, the each pivot roller assembly further includes one or more spherical bearings.

In some embodiments, the system further includes a motor configured to drive one or more of the lower roller and the plurality of pivot roller assemblies.

In some embodiments, the motor is a 3 horsepower motor.

In some embodiments, one or more of the lower roller, the plurality of pivot roller assemblies, and the idler roller are coated with high friction coating.

In some embodiments, one or more of the lower roller, the plurality of pivot roller assemblies, and the idler roller are coated with solid polyurethane.

In some embodiments, the lower roller is coated with rubber.

The system of claim 1, wherein the one or more forces may include vertical and horizontal forces.

In some embodiments, the system further includes a pin shaft configured to selectively lock in place one or more of the lower roller, the idler roller, and the plurality of pivot roller assemblies.

According to various embodiments, there is provided a method for rejecting one or more wall boards, the method including inserting one or more wall boards into a wall board rejection system, the system including a frame; a lower roller configured to operably engage the one or more wall boards; a plurality of pivot roller assemblies configured to apply one or more forces to the lower roller, wherein the lower roller is configured to apply the one or more forces to the one or more wall boards to which the lower roller is operably engaged; at least one idler roller, wherein the at least one idler roller is aligned with the lower roller; a controller configured to send one or more signals to the plurality of pivot roller assemblies, wherein the one or more signals are configured to adjust the one or more forces applied to the lower roller based on one or more thresholds. The method further includes operably engaging, by the lower roller, the one or more wall boards. The method further including applying, by the plurality of pivot roller assemblies, the one or more forces to the lower roller; applying, by the lower roller, the one or more forces to the one or more wall boards; rejecting, by the system, the one or more wall boards in instances where the one or more wall boards exceed the one or more thresholds.

The above summary is provided merely for purposes of summarizing some example various embodiments to provide a basic understanding of some embodiments of the disclosure. Accordingly, it will be appreciated that the above-described various embodiments are merely examples. It will be appreciated that the scope of the disclosure encompasses many potential various embodiments in addition to those here summarized, some of which will be further described below.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is diagram illustrating example architecture for an example control device in accordance with various embodiments of the present disclosure;

FIG. 2 is a schematic of an example management computing entity for an example control device in accordance with various embodiments of the present disclosure;

FIG. 3 is a schematic of an example user computing entity for an example control device in accordance with various embodiments of the present disclosure;

FIG. 4A is an isometric view of an example board reject system in accordance with various embodiments of the present disclosure;

FIG. 4B is an angled view of an example board reject system in accordance with various embodiments of the present disclosure;

FIG. 5A is a front view of an example pivot roller assembly for an example board reject system in accordance with various embodiments of the present disclosure;

FIG. 5B is a cross-sectional view of an example pivot roller assembly for an example board reject system in accordance with various embodiments of the present disclosure;

FIG. 6A is a side view of an example board reject system in accordance with various embodiments of the present disclosure;

FIG. 6B is a front view of an example pivot roller assembly for an example board reject system in accordance with various embodiments of the present disclosure; and

FIG. 7 is a flow chart illustrating an example method using an example wall board rejection system in accordance with various embodiments of the present disclosure.

### DETAILED DESCRIPTION OF SOME EXAMPLE VARIOUS EMBODIMENTS

Various embodiments of the present disclosure now will be described more fully hereinafter with reference to the accompanying drawings, in which some, but not all various embodiments of the disclosure are shown. Indeed, this disclosure may be embodied in many different forms and should not be construed as limited to the various embodiments set forth herein; rather, these various embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers may refer to like elements throughout. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily may refer to the same embodiment).

Various embodiments of the present disclosure may be implemented as computer program products that comprise articles of manufacture. Such computer program products may include one or more software components including, for example, applications, software objects, methods, data structures, and/or the like. A software component may be coded in any of a variety of programming languages. An illustrative programming language may be a lower-level programming language such as an assembly language associated with a particular hardware architecture and/or operating system platform/system. A software component comprising assembly language instructions may require conversion into executable machine code by an assembler prior to execution by the hardware architecture and/or platform/system. Another example programming language may be a higher-level programming language that may be portable across multiple architectures. A software component comprising higher-level programming language instructions may require conversion to an intermediate representation by an interpreter or a compiler prior to execution.

As should be appreciated, various embodiments of the present disclosure may also be implemented as methods, apparatuses, systems, computing devices, computing entities, and/or the like. As such, various embodiments of the present disclosure may take the form of a data structure, apparatus, system, computing device, computing entity, and/or the like executing instructions stored on a computer-readable storage medium to perform certain steps or operations. Thus, various embodiments of the present disclosure may also take the form of an entirely hardware embodiment, an entirely computer program product embodiment, and/or an embodiment that comprises combination of computer program products and hardware performing certain steps or operations.

Various embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary various embodiments, retrieval, loading, and/or execution may be performed in parallel such that multiple instructions are retrieved, loaded, and/or executed together. Thus, such various embodiments can produce specifically-configured machines performing the steps or operations specified in the block diagrams and flowchart illustrations. Accordingly, the block diagrams and flowchart illustrations support various combinations of various embodiments for performing the specified instructions, operations, or steps.

### Computer Program Products, Systems, Methods, and Computing Entities

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially, such that one instruction is retrieved, loaded, and executed at a time. In some exemplary embodiments, retrieval, loading, and/or execution may be performed in parallel, such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### Exemplary System Architecture

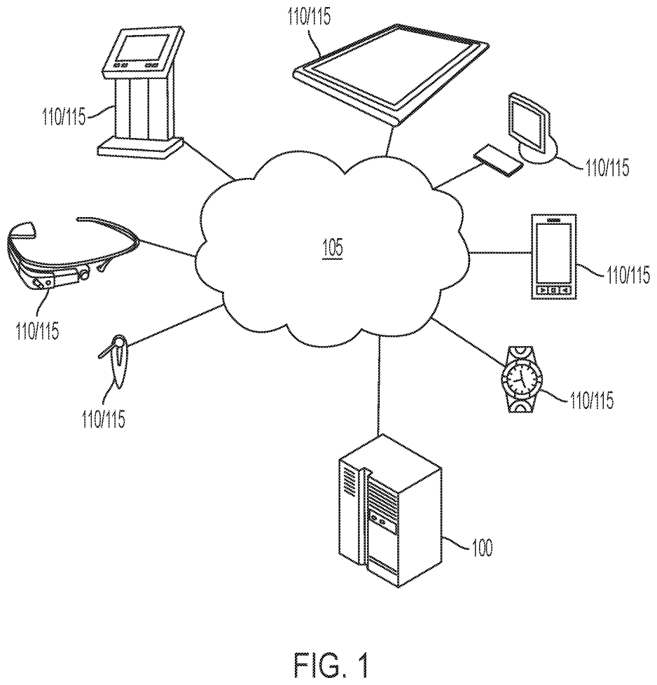

FIG. 1 provides an illustration of an exemplary system architecture that may be used in accordance with various embodiments of the present disclosure. As shown in FIG. 1, the architecture may be one or more management computing entities 100, one or more networks 105, and one or more user computing entities 110. Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture.

### Exemplary Management Computing Entity

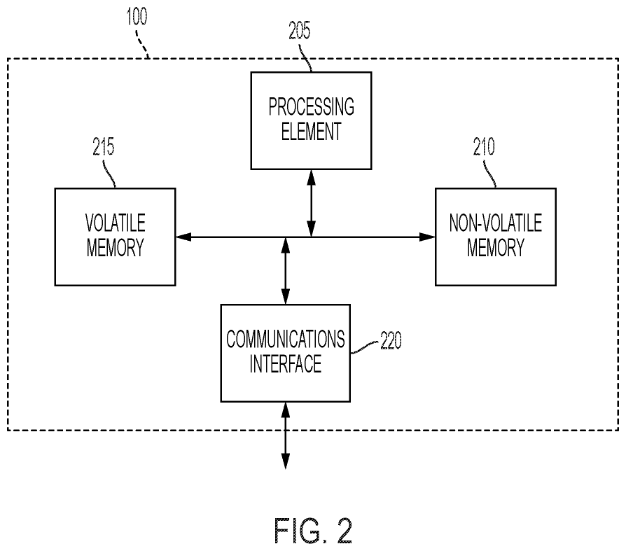

FIG. 2 provides a schematic of a management computing entity 100 according to one embodiment of the present disclosure. In general, the terms computing entity, computer, entity, device, system, and/or similar words used herein interchangeably may refer to, for example, one or more computers, computing entities, desktop computers, mobile phones, tablets, phablets, notebooks, laptops, distributed systems, gaming consoles (e.g., Xbox, Play Station, Wii), watches, glasses, iBeacons, proximity beacons, key fobs, radio frequency identification (RFID) tags, ear pieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the management computing entity 100 may also include one or more communications interfaces 220 for communicating with various computing entities, such as by communicating data, content, information, and/or similar terms used herein interchangeably that can be transmitted, received, operated on, processed, displayed, stored, and/or the like. For instance, the management computing entity 100 may communicate with user computing entities 110 and/or a variety of other computing entities.

As shown in FIG. 2, in one embodiment, the management computing entity 100 may include or be in communication with one or more processing elements 205 (also referred to as processors, processing circuitry, and/or similar terms used herein interchangeably) that communicate with other elements within the management computing entity 100 via a bus, for example. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In one embodiment, the management computing entity 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the management computing entity 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the management computing entity 100 with the assistance of the processing element 205 and operating system.

As indicated, in one embodiment, the management computing entity 100 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the management computing entity 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the management computing entity 100 may include or be in communication with one or more input elements, such as a keyboard input, a mouse input, a touch screen/display input, motion input, movement input, audio input, pointing device input, joystick input, keypad input, and/or the like. The management computing entity 100 may also include or be in communication with one or more output elements (not shown), such as audio output, video output, screen/display output, motion output, movement output, and/or the like.

As will be appreciated, one or more of the management computing entity's 100 components may be located remotely from other management computing entity 100 components, such as in a distributed system. Furthermore, one or more of the components may be combined and additional components performing functions described herein may be included in the management computing entity 100. Thus, the management computing entity 100 can be adapted to accommodate a variety of needs and circumstances. As will be recognized, these architectures and descriptions are provided for exemplary purposes only and are not limiting to the various embodiments.

### Exemplary User Computing Entity

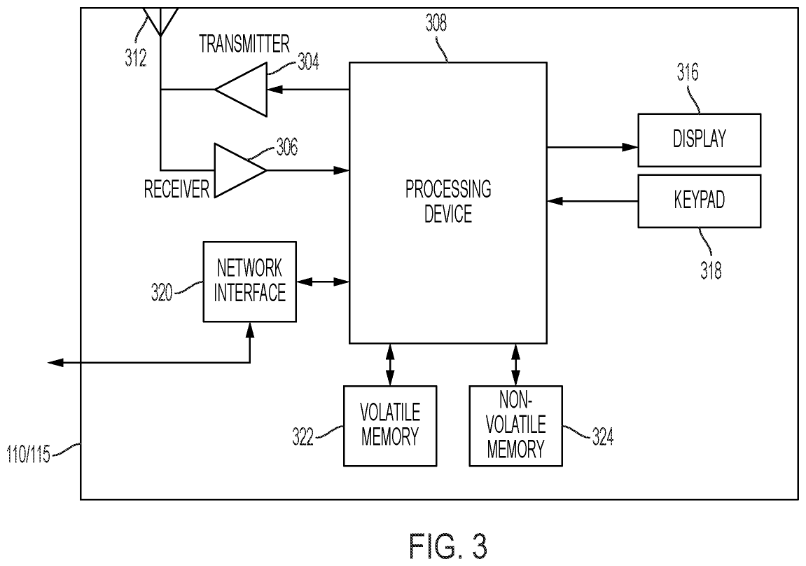

A user may be an individual, a family, a company, an organization, an entity, a department within an organization, a representative of an organization and/or person, and/or the like. To do so, a user may operate a user computing entity 110 that includes one or more components that are functionally similar to those of the management computing entity 100. FIG. 3 provides an illustrative schematic representative of a user computing entity 110 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. User computing entities 110 can be operated by various parties. As shown in FIG. 3, the user computing entity 110 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, respectively.

The signals provided to and received from the transmitter 304 and the receiver 306, respectively, may include signaling information in accordance with air interface standards of applicable wireless systems. In this regard, the user computing entity 110 may be capable of operating with one or more air interface standards, communication protocols, modulation types, and access types. More particularly, the user computing entity 110 may operate in accordance with any of a number of wireless communication standards and protocols, such as those described above with regard to the management computing entity 100. In a particular embodiment, the user computing entity 110 may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the user computing entity 110 may operate in accordance with multiple wired communication standards and protocols, such as those described above with regard to the management computing entity 100 via a network interface 320.

Via these communication standards and protocols, the user computing entity 110 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The user computing entity 110 can also download changes, add-ons, and updates, for instance, to its firmware, software (e.g., including executable instructions, applications, program modules), and operating system.

According to one embodiment, the user computing entity 110 may include location determining aspects, devices, modules, functionalities, and/or similar words used herein interchangeably. For example, the user computing entity 110 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information can be determined by triangulating the user computing entity's 110 position in connection with a variety of other systems, including cellular towers, Wi-Fi access points, and/or the like. Similarly, the user computing entity 110 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The user computing entity 110 may also comprise an IETM viewer (that can include a display 316 coupled to a processing element 308) and/or a viewer (coupled to a processing element 308). For example, the IETM viewer may be a user application, browser, user interface, graphical user interface, and/or similar words used herein interchangeably executing on and/or accessible via the user computing entity 110 to interact with and/or cause display of information from the management computing entity 100, as described herein. The term “viewer” is used generically and is not limited to “viewing.” Rather, the viewer is a multi-purpose digital data viewer capable and/or receiving input and providing output. The viewer can comprise any of a number of devices or interfaces allowing the user computing entity 110 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the user computing entity 110 and may include a full set of alphabetic keys or set of keys that may be activated to provide a full set of alphanumeric keys. In addition to providing input, the viewer can be used, for example, to activate or deactivate certain functions, such as screen savers and/or sleep modes.

The user computing entity 110 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the user computing entity 110. As indicated, this may include a user application that is resident on the entity or accessible through a browser or other IETM viewer for communicating with the management computing entity 100 and/or various other computing entities.

In another embodiment, the user computing entity 110 may include one or more components or functionality that are the same or similar to those of the management computing entity 100, as described in greater detail above. As will be recognized, these architectures and descriptions are provided for exemplary purposes only and are not limiting to the various embodiments.

### Exemplary System Operations

The logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. Greater or fewer operations may be performed than shown in the figures and described herein. These operations may also be performed in a different order than those described herein.

As described above, the management computing entity 100 and/or user computing entity 110 may be configured for storing technical documentation (e.g., data) in an IETM, providing access to the technical documentation to a user via the IETM, and/or providing functionality to the user accessing the technical documentation via the IETM. In general, the technical documentation is typically made up of volumes of text along with other media objects. In many instances, the technical documentation is arranged to provide the text and/or the media objects on an item. For instance, the item may be a product, machinery, equipment, a system, and/or the like such as, for example, a bicycle or an aircraft.

Accordingly, the technical documentation may provide textual information along with non-textual information (e.g., one or more visual representations) of the item and/or components of the item. Textual information generally includes alphanumeric information and may also include different element types such as graphical features, controls, and/or the like. Non-textual information generally includes media content such as illustrations (e.g., 2D and 3D graphics), video, audio, and/or the like. Although the non-textual information may also include alphanumeric information.

The technical documentation may be provided as digital media in any of a variety of formats, such as JPEG, JFIF, JPEG2000, EXIF, TIFF, RAW, DIV, GIF, BMP, PNG, PPM, MOV, AVI, MP4, MKV, and/or the like. In addition, the technical documentation may be provided in any of a variety of formats, such as DOCX, HTMLS, TXT, PDF, XML, SGML, JSON and/or the like. As noted, the technical documentation may provide textual and non-textual information of various components of the item. For example, various information may be provided with respect to assemblies, sub-assemblies, sub-sub-assemblies, systems, subsystems, sub-subsystems, individual parts, and/or the like associated with the item.

In various embodiments, the technical documentation for the item may be stored and/or provided in accordance with S1000D standards and/or a variety of other standards. According to various embodiments, the management computing entity 100 and/or user computing entity 110 provides functionality in the access and use of the technical documentation provided via the IETM in accordance with user instructions and/or input received from the user via an IETM viewer (e.g., a browser, a window, an application, a graphical user interface, and/or the like).

Accordingly, in particular embodiments, the IETM viewer is accessible from a user computing entity 110 that may or may not be in communication with the management computing entity 100. For example, a user may sign into the management computing entity 100 from the user computing entity 110 or solely into the user computing entity 110 to access technical documentation via the IETM and the management computing entity 100 and/or user computing entity 110 may be configured to recognize any such sign in request, verify the user has permission to access the technical documentation (e.g., by verifying the user's credentials), and present/provide the user with various displays of content for the technical documentation via the IETM viewer (e.g., displayed on display 316).

Further detail is now provided with respect to various functionality provided by embodiments of the present disclosure. As one of ordinary skill in the art will understand in light of this disclosure. The modules now discussed and configured for carrying out various functionality may be invoked, executed, and/or the like by the management computing entity 100, the user computing entity 110, and/or a combination thereof depending on the embodiment.

According to various embodiments, the management computing entity 100 and its various components may be integrated into the wall board rejection system that will now be described. In some embodiments, the entity 100 and its components may be integrated into the wall board rejection system, while in other embodiments only some components of the entity may be integrated into the system.

### Example Wall Board Rejection Systems

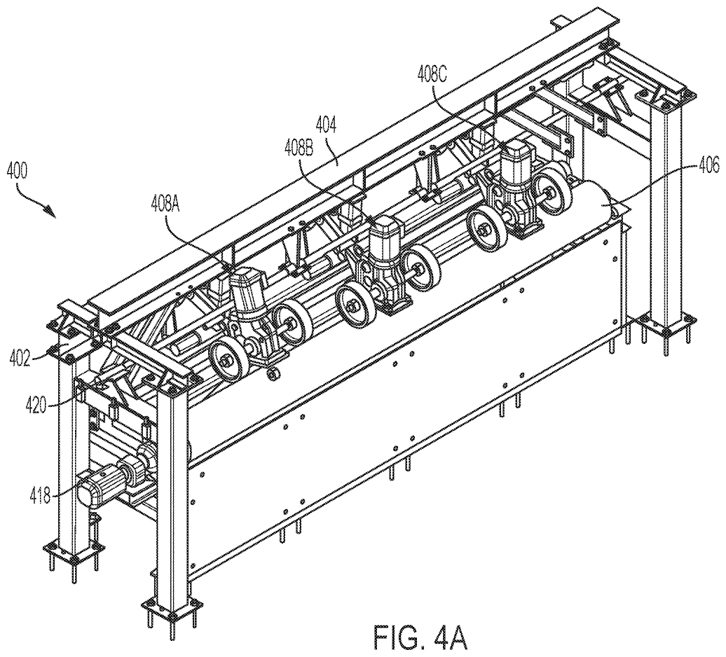

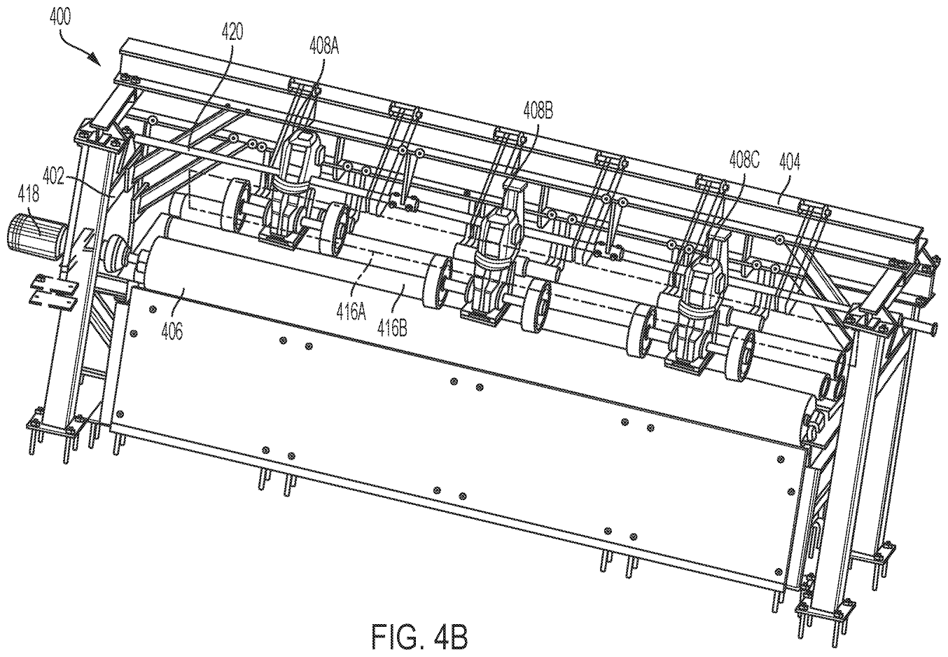

Referring now to FIGS. 4A and 4B, in some embodiments, a rejection system 400 is provided. In some embodiments, the system 400 may be configured to receive information about the size of an object (e.g., a wall board) and then reject the object (e.g., prevent the wall board from entering a production line) based on one or more criterion. In some embodiments, the wall board may be gypsum or fiberglass. For example, the system 400 may receive information (e.g., from a sensor or other system in the production line, or from operator input) that the wall board is too long for the production line (e.g., the wall board is over 20 feet long). In other embodiments, the system 400 may receive different criterion that warrant rejecting the object from the production line. In some embodiments, the system 400 may be in communication with one or more other systems on the production line. For example, the system 400 may notify other systems on the production line that a wall board was too large and was rejected, and the other systems on the production line may update their processes accordingly.

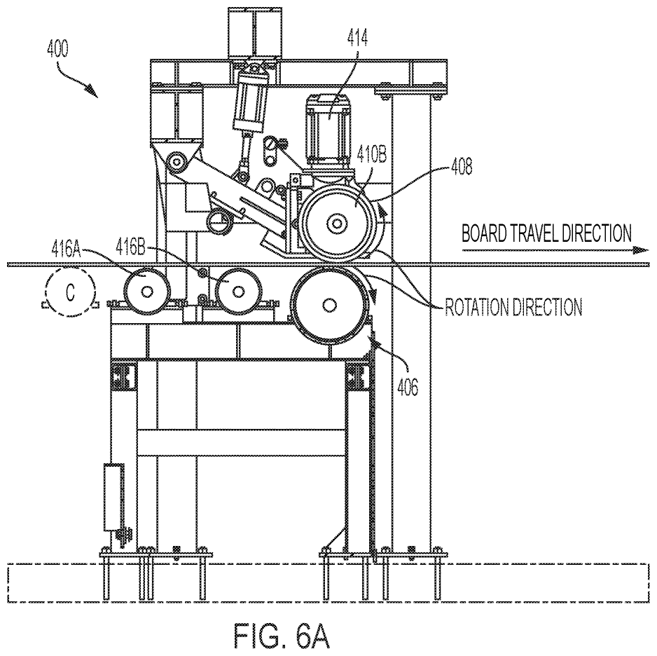

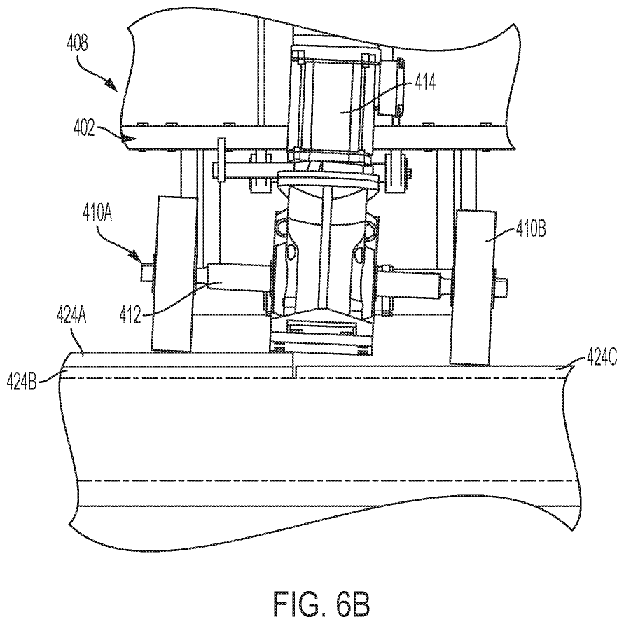

In some embodiments, the system 400 may include a frame 402. In some embodiments, the frame 402 may be fixed to the ground by one or more legs. In some embodiments, the frame 402 may be fixed in a position placed in front of the entrance to a production line, such as a production line for a wallboard manufacturing process (wallboards 424A, 424B, and 424C are shown in at least FIGS. 6A and 6B). In some embodiments, the frame 402 may be a steel frame. In some embodiments, the frame 402 may include a top beam (such as an I-beam) 404. In some embodiments, various components of the system 400 may be fixedly or operably attached to the top beam 404.

In some embodiments, the system may include one or more rollers that may be configured to accept or reject an example wall board that is attempting to enter the production line. In some embodiments, the rollers may be fixedly or operably connected to the frame 402 of the system 400. In some embodiments, the rollers may operate entirely autonomously and in other embodiments the rollers may be configured to be controlled in at least some capacity by one or more technicians. In some embodiments, the rollers may be in communication with each other and adjust their operation based on the operation of other rollers. In some embodiments, the rollers may include a controller that may be operatively connected with the computing entity 100 and the various components previously described. In some embodiments, the computing entity 100 may be configured to selectively activate and deactivate the rollers depending on whether objects (e.g., wall boards) need to be ejected from the production line (that is, the rollers are active only when wall boards need to be ejected from the production line and inactive at other times). In some embodiments, the rollers may incorporate feedback mechanisms and adjust their operation according to the received feedback. In some embodiments, the controller may be configured to send signals to the pivot roller assemblies 408A-C, and, in some embodiments, the signals may be configured to adjust the force applied by the pivot roller assemblies 408A-C depending on one or more factors of the wall boards entering the system 400 (e.g., the size of the wall boards).

In some embodiments, the system 400 may include a motor reducer 418. In some embodiments, the motor reducer 418 may be a 3 horsepower motor reducer. In some embodiments, the motor reducer 418 may be configured to drive one or more rollers of the system 400. In some embodiments, the rollers may operate simultaneously as they are driven by the motor reducer 418, while in other embodiments one or more rollers may operate independently of the other rollers. In some embodiments, the motor reducer 418 may be controlled by the computing entity 100 and various components previously described. In some embodiments, the motor reducer 418 may vary the speed of the various rollers.

The various rollers of the system will now be described in greater detail.

In some embodiments, the system 400 may include a bottom roller 406. In some embodiments, the bottom roller 406 may be fixedly attached to the frame 402. In some embodiments, the bottom roller 404 may be disposed along an axis defined by a shaft, which may be fixed to the frame 402 by, for example, one or more fasteners. In some embodiments, the bottom roller 404 may be a lagged, driven roller. In some embodiments, the bottom roller 406 may be configured to engage with one or more objects (e.g., wall board) as they enter the system 400. One bottom roller 406 is shown in FIGS. 4A and 4B, but in some embodiments more bottom rollers 406 may be used as necessary. In some embodiments, the wall board may be inserted into the system 400 such that the lower roller 406 applies a downward force (by means of top rollers, which will be described in greater detail later in this disclosure) onto the lower surface of a wall board. In some embodiments, if the board that is being engaged is too large, then it will be rejected from the system by the downward force applied by the lower roller 406.

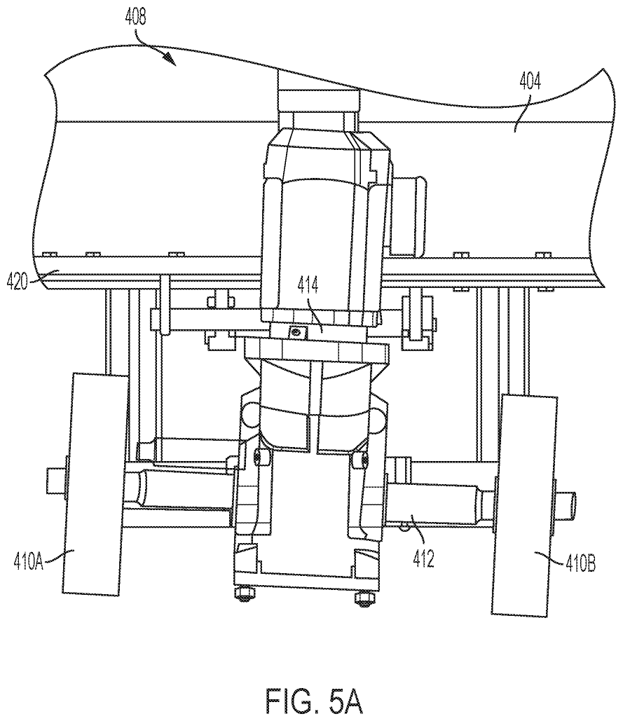

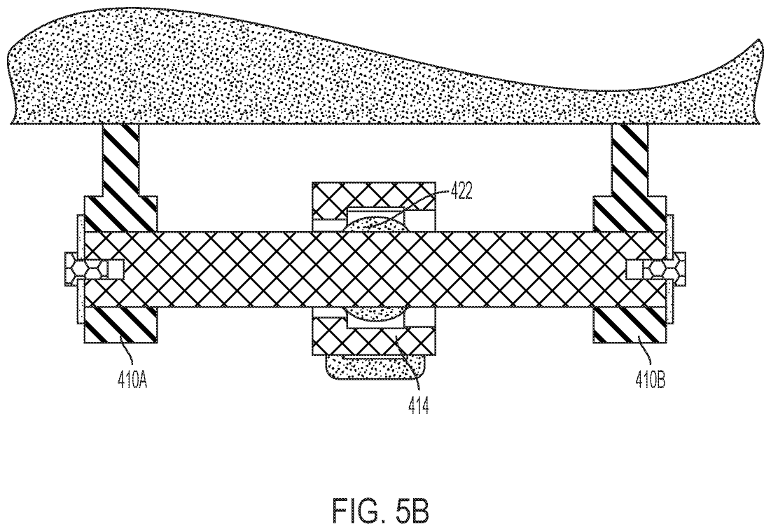

Still referring to FIGS. 4A and 4B but also referring to FIGS. 5A and 5B, in some embodiments, the system 400 may include one or more pivot roller assemblies 408A, 408B, 408C that may be top rollers positioned above the bottom roller 406. Three pivot roller assemblies 408 are shown in FIGS. 4A and B, but a system 400 may have greater than or fewer than three assemblies 408, according to various embodiments.

In some embodiments, the pivot roller assemblies 408A-C may be configured to apply a downward force onto the bottom roller 406 to subsequently apply force to an object (e.g., wall board) being inserted into the system 400. In some embodiments, the pivot roller assemblies 408A-C may be configured to apply a uniform force across the three rollers, while in other embodiments the roller assemblies 408A-C may selectively apply force separately, as will be described in greater detail later in the disclosure. In some embodiments, the pivot roller assemblies 408A-C may each apply substantial force to the lower roller 406, in both vertical and horizontal directions. In some embodiments, the force applied may be approximately 400 lbs. of vertical force and approximately 200 lbs. of horizontal force. In some embodiments, the pivot roller assemblies 408A-C may be operably controlled by the computing entity 100 and its various components as previously described. In some embodiments, the force applies by the pivot roller assemblies 408A-C may be configured based on the thickness of the wall board that is entering the system 400. For example, for heavy, rough fiberglass-faced boards, additional force may need to be applied by the pivot roller assemblies 408A-C to the lower roller 406 to eject the boards from the production line. In some embodiments, the computing devices previously described in this disclosure may be configured to set the appropriate force of the pivot roller assemblies 408A-C depending on the type of wall board entering the system 400. In some embodiments, one or more thresholds may be programmed into the controller, and the controller may be configured to send one or more signals to the one or more pivot roller assemblies 408A-C to reject the wall boards from the system if the wall boards exceed the one or more thresholds.

In some embodiments, and as shown in at least FIGS. 5A, 5B, 6A, and 6B a pivot roller assembly 408 may include a pair of roller wheels 410A, 410B that are disposed along a roller shaft 412. In some embodiments, the roller wheels 410A, 410B may be disposed on opposite ends of the shaft 412. In some embodiments, the pivot roller assembly 408 may include at least one cylinder 414, which may be a pneumatic cylinder. In some embodiments, the cylinder 414 may be configured to raise and lower the respective pivot roller assembly 408. In some embodiments, the pivot roller assembly 408 may be fixedly attached to the cylinder 414, which may be fixed to the beam 404. In some embodiments, the cylinder 414 may be selectively activated and deactivated depending on the needs of the system 400. For example, in some embodiments, the cylinder for one assembly (e.g., 408A) may be deactivated, while the cylinders for two other assemblies (e.g., 408B, 408C) may be activated. In some embodiments, a pivot roller assembly 408 may pivot horizontally and/or vertically to allow for different sizes of boards to pass through the system. In some embodiments, and as shown in FIG. 5B, the pivot roller assembly 408 may include one or more spherical bearings 422 that may be configured to allow the respective pivot roller assemblies 408A-C to pivot vertically and horizontally. In some embodiments, the spherical bearings 422 may be configured to tilt the shaft 412 vertically and horizontally with respect to the frame 402. This vertical tilt may allow for wall boards with different thickness to pass through the system 400 (i.e., not be rejected) while maintaining contact between the rollers and the wall boards. This horizontal tilt may allow for multiple wall boards of different thickness and/or overlapping wall boards (e.g., 424A and 424B in FIG. 6B) to pass through the system 400 while maintaining contact between the rollers and the wall boards.

In some embodiments, the system 400 may include one or more idler rollers 416A, 416B. Two idler rollers are shown in at least FIGS. 4A and 4B, but a system 400 may have greater than or fewer than three idler rollers 416A, 416B, according to various embodiments. In some embodiments, one or more of the idler rollers 416A, 416B may be disposed along the length of the lower roller 406. In some embodiments, the one or more of the idler rollers 416A, 416B may be configured to rotate with the lower roller 406.

In some embodiments, the system 400 may include a pin shaft 420 that may be fixedly or operably attached to the frame 402. In some embodiments, the pin shaft 420 may be configured to hold up the pivot roller assemblies 408A-C to allow for maintenance, removal, and/or replacement of the various rollers.

In some embodiments, the various rollers of the system 400 may be coated with high friction coating. For example, the pivot roller assemblies 408A-C may be coated with solid polyurethane. As another example, in some embodiments, the bottom roller 406 may be coated with rubber.

### Example Methods of Rejecting Wall Boards

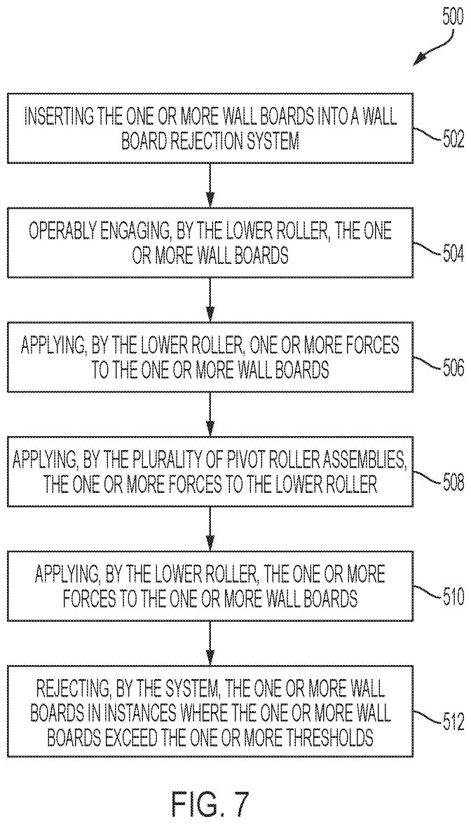

FIG. 7 is a flow chart illustrating an example method 500 using an example wall board rejection system in accordance with various embodiments of the present disclosure. The method 500 is described in reference to the system 400 and its various components, but the example method 500 may be performed using other suitable systems and their various components.

According to various embodiments, the method 500 includes a step 502 of inserting the one or more wall boards into a wall board rejection system (e.g., system 400). In some embodiments, the method 500 includes a step 505 of operably engaging, by the lower roller, the one or more wall boards. In some embodiments, the method 500 includes a step 506 of applying, by the lower roller, one or more forces to the one or more wall boards. In some embodiments, the method 500 includes a step 508 of applying, by the plurality of pivot roller assemblies, the one or more forces to the lower roller. In some embodiments, the method 500 includes a step 510 of applying, by the lower roller, the one or more forces to the one or more wall boards. In some embodiments, the method 500 includes a step 512 of rejecting, by the system, the one or more wall boards in instances where the one or more wall boards exceed the one or more thresholds.

### CONCLUSION

Many modifications and other various embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific various embodiments disclosed and that modifications and other various embodiments are intended to be included within the scope of the appended claims. Although specific terms are employed herein, they are used in a generic and descriptive sense only and not for purposes of limitation.

1. A system for rejecting one or more wall boards, the system comprising:
a frame;
a lower roller configured to operably engage the one or more wall boards;
a plurality of pivot roller assemblies configured to apply one or more forces to the lower roller, wherein the lower roller is configured to apply the one or more forces to the one or more wall boards to which the lower roller is operably engaged;
at least one idler roller, wherein the at least one idler roller is aligned with the lower roller;
a controller configured to send one or more signals to the plurality of pivot roller assemblies, wherein the one or more signals are configured to adjust the one or more forces applied to the lower roller based on one or more thresholds,
wherein the one or more forces are configured to reject the one or more wall boards if the one or more wall boards exceeds the one or more thresholds.

2. The system of claim 1, wherein the one or more thresholds comprise a length of the one or more wall boards.

3. The system of claim 1, wherein the one or more wall boards comprise a material selected from a group consisting of: gypsum and fiberglass.

4. The system of claim 1, wherein the plurality of pivot roller assemblies comprises a first pivot roller assembly, a second pivot roller assembly, and a third pivot roller assembly, wherein the first pivot roller assembly is configured to apply a first force to the lower roller, the second pivot roller assembly is configured to apply a second force to the lower roller, and the third pivot roller assembly is configured to apply a third force to the lower roller.

5. The system of claim 1, wherein each pivot roller assembly of the plurality of pivot roller assemblies comprises a pneumatic cylinder, a roller shaft operably connected to the pneumatic cylinder, and one or more wheels operably connected to the roller shaft, and wherein the pneumatic cylinder is configured to tilt the roller shaft horizontally or vertically with respect to the frame.

6. The system of claim 5, wherein the each pivot roller assembly further comprises one or more spherical bearings.

7. The system of claim 1, further comprising a motor configured to drive one or more of the lower roller and the plurality of pivot roller assemblies.

8. The system of claim 7, wherein the motor is a 3 horsepower motor.

9. The system of claim 1, wherein one or more of the lower roller, the plurality of pivot roller assemblies, and the idler roller are coated with high friction coating.

10. The system of claim 1, wherein one or more of the lower roller, the plurality of pivot roller assemblies, and the idler roller are coated with solid polyurethane.

11. The system of claim 1, wherein the lower roller is coated with rubber.

12. The system of claim 1, wherein the one or more forces may comprise vertical and horizontal forces.

13. The system of claim 1, further comprising a pin shaft configured to selectively lock in place one or more of the lower roller, the idler roller, and the plurality of pivot roller assemblies.

14. A method for rejecting one or more wall boards, the method comprising:
inserting the one or more wall boards into a wall board rejection system, the system comprising:
a frame;
a lower roller configured to operably engage the one or more wall boards;
a plurality of pivot roller assemblies configured to apply one or more forces to the lower roller, wherein the lower roller is configured to apply the one or more forces to the one or more wall boards to which the lower roller is operably engaged;
at least one idler roller, wherein the at least one idler roller is aligned with the lower roller;
a controller configured to send one or more signals to the plurality of pivot roller assemblies, wherein the one or more signals are configured to adjust the one or more forces applied to the lower roller based on one or more thresholds;
operably engaging, by the lower roller, the one or more wall boards;
applying, by the plurality of pivot roller assemblies, the one or more forces to the lower roller;
applying, by the lower roller, the one or more forces to the one or more wall boards;
rejecting, by the system, the one or more wall boards in instances where the one or more wall boards exceed the one or more thresholds.
